(19) United States
(12) Patent Application Publication
(10) Pub. No.: US 2013/0274002 A1
(43) Pub. Date: Oct. 17, 2013

(54) GAME SYSTEM

(71) Applicant: Osamu Ikeda, Tokyo (JP)

(72) Inventor: Osamu Ikeda, Tokyo (JP)

(21) Appl. No.: 13/851,871

(22) Filed: Mar. 27, 2013

(30) Foreign Application Priority Data
Apr. 12, 2012 (JP) 2012-090988

(51) Int. Cl. A63F 13/12

(52) U.S. Cl. CPC A63F 13/12
USPC 463/25

(57) ABSTRACT

One object is to provide a game system that can technically restrain real money trade. In accordance with one aspect, a game system according to an embodiment of the present invention includes: a bid data generating unit configured to generate bid data including game medium information related to a bid game medium and not including player specifying information that specifies a bidder player; and a second display control unit configured to allow a bid screen generated based on bid data to be displayed in the game being played by an exhibitor player.

### CROSS-REFERENCE TO RELATED APPLICATIONS

This application is based on and claims the benefit of priority from Japanese Patent Application Serial No. 2012-090988 (filed on Apr. 12, 2012), the contents of which are hereby incorporated by reference in their entirety.

### TECHNICAL FIELD

The present invention relates to a game system.

### BACKGROUND

So-called online games have become popular, wherein a video game provided by a game system implemented on a server device simultaneously progresses on a plurality of terminal devices connected to the game system via a communication network. In a collectible card game, a kind of online game, a player collects electronic cards, and combats other players and/or fulfill a mission by using the cards, thereby progressing the game.

Online games may have built-in functions for exchange of electronic cards and items between players, so as to encourage social interaction between players. For example, Japanese Patent Application Publication No. 2009-187143 (the “'143 Publication”) discloses a technique for exchange of items used in an online game between players.

As disclosed in the '143 Publication, some players sell and buy cards and items in real currency; this is called real money trade. If such a real money trade is left uncontrolled, only part of players can play the game with a remarkably advantageous condition; this may cause loss of game balance. In order to tackle this problem, online game providers prohibit real money trade in user agreement and suspend play of the game for users who have violated the user agreement, thereby trying to restrain the real money trade.

### SUMMARY

However, real money trade cannot be sufficiently restrained by strict application of user agreement. Therefore, various embodiments of the present invention provide a game system that technically restrains real money trade.

A game system according to an embodiment of the present invention comprises: a game program storage unit configured to store a game program for performing a game on a terminal device; a game medium identification information storage unit configured to store first game medium identification information unique to a first game medium for use in the game and second game medium identification information unique to a second game medium for use in the game, wherein the first game medium identification information is stored in association with first player identification information unique to a first player owning the first game medium, and wherein the second game medium identification information is stored in association with second player identification information unique to a second player owning the second game medium; a player specifying information storage unit configured to store first player specifying information capable of specifying the first player and second player specifying information capable of specifying the second player; an exhibition data generating unit configured to generate exhibition data including first game medium information related to the first game medium and the first game medium identification information; a first display control unit configured to allow an exhibition screen generated based on the exhibition data to be displayed in the game being played by the second player; a bid request receiving unit configured to receive from the second player a bid request including at least the first game medium identification information and the second game medium identification information; a bid data generating unit configured to generate, based on the bid request, bid data including second game medium information related to the second game medium and not including the second player specifying information; a second display control unit configured to allow a bid screen generated based on the bid data to be displayed in the game being played by the first player; an exchange confirmation request receiving unit configured to receive from the first player an exchange confirmation request including at least the second game medium identification information; and a game medium identification information updating unit configured to update the game medium identification information storage unit based on the exchange confirmation request such that the first game medium identification information is stored in association with the second player identification information, and the second game medium identification information is stored in association with the first player identification information.

A game system according to an embodiment of the present invention comprises: a game program storage unit configured to store a game program for performing a game on a terminal device; a game medium identification information storage unit configured to store first game medium identification information unique to a first game medium for use in the game and second game medium identification information unique to a second game medium for use in the game, wherein the first game medium identification information is stored in association with first player identification information unique to a first player owning the first game medium, and wherein the second game medium identification information is stored in association with second player identification information unique to a second player owning the second game medium; a player specifying information storage unit configured to store first player specifying information capable of specifying the first player and second player specifying information capable of specifying the second player; an exhibition data generating unit configured to generate exhibition data including first game medium information related to the first game medium and the first game medium identification information and not including the first player specifying information; a first display control unit configured to allow an exhibition screen generated based on the exhibition data to be displayed in the game being played by the second player; a bid request receiving unit configured to receive from the second player a bid request including at least the first game medium identification information and the second game medium identification information; a bid data generating unit configured to generate, based on the bid request, bid data including second game medium information related to the second game medium; a second display control unit configured to allow a bid screen generated based on the bid data to be displayed in the game being played by the first player; an exchange confirmation request receiving unit configured to receive from the first player an exchange confirmation request including at least the second game medium identification information; and a game medium identification information updating unit configured to update the game medium identification information storage unit based on the exchange confirmation request such that the first game medium identification information is stored in association with the second player identification information, and the second game medium identification information is stored in association with the first player identification information.

A game system according to an embodiment of the present invention comprises: game program storage unit configured to store a game program for performing a game on a terminal device; a group management unit configured to randomly grouping a plurality of players of the game into a plurality of groups and associate the plurality of groups with each other, a game medium identification information storage unit configured to store first game medium identification information unique to a first game medium for use in the game and second game medium identification information unique to a second game medium for use in the game, wherein the first game medium identification information is stored in association with first player identification information unique to a first player owning the first game medium, and wherein the second game medium identification information is stored in association with second player identification information unique to a second player owning the second game medium; a player specifying information unit storage unit configured to store the first player specifying information capable of specifying the first player and the second player specifying information capable of specifying the second player; an exhibition data generating unit configured to generate exhibition data including first game medium information related to the first game medium and the first game medium identification information; a first display control unit configured to allow an exhibition screen generated based on the exhibition data to be displayed in the game being played by the second player only when a first group including the first player is associated with a group including the second player; a bid request receiving unit configured to receive from the second player a bid request including at least the first game medium identification information and the second game medium identification information; a bid data generating unit configured to generate, based on the bid request, bid data including second game medium information related to the second game medium; a second display control unit configured to allow a bid screen generated based on the bid data to be displayed in the game being played by the first player; an exchange confirmation request receiving unit configured to receive from the first player an exchange confirmation request including at least the second game medium identification information; and a game medium identification information updating unit configured to update the game medium identification information storage unit based on the exchange confirmation request such that the first game medium identification information is stored in association with the second player identification information, and the second game medium identification information is stored in association with the first player identification information.

A game system according to an embodiment of the present invention comprises: a game program storage unit configured to store a game program for performing a game on a terminal device; a player management unit configured to store player identification information unique to each of the plurality of players in dynamic association with player identification information of other players, a game medium identification information storage unit configured to store first game medium identification information unique to a first game medium for use in the game and second game medium identification information unique to a second game medium for use in the game, wherein the first game medium identification information is stored in association with first player identification information unique to a first player owning the first game medium, and wherein the second game medium identification information is stored in association with second player identification information unique to a second player owning the second game medium; a player specifying information storage unit configured to store first player specifying information capable of specifying the first player and second player specifying information capable of specifying the second player; an exhibition data generating unit configured to generate exhibition data including first game medium information related to the first game medium and the first game medium identification information; a first display control unit configured to allow an exhibition screen generated based on the exhibition data to be displayed in the game being played by the second player only when the player management unit associates the second player with the first player; a bid request receiving unit configured to receive from the second player a bid request including at least the first game medium identification information and the second game medium identification information; a bid data generating unit configured to generate, based on the bid request, bid data including second game medium information related to the second game medium; a second display control unit configured to allow a bid screen generated based on the bid data to be displayed in the game being played by the first player; an exchange confirmation request receiving unit configured to receive from the first player an exchange confirmation request including at least the second game medium identification information; and a game medium identification information updating unit configured to update the game medium identification information storage unit based on the exchange confirmation request such that the first game medium identification information is stored in association with the second player identification information, and the second game medium identification information is stored in association with the first player identification information.

A method using a computer comprising the steps of: storing game programs for performing games on a terminal device; storing first game medium identification information unique to a first game medium for use in the game and second game medium identification information unique to a second game medium for use in the game, wherein the first game medium identification information is stored in association with first player identification information unique to a first player owning the first game medium, and wherein the second game medium identification information is stored in association with second player identification information unique to a second player owning the second game medium; storing the first player specifying information capable of specifying the first player and the second player specifying information capable of specifying the second player; generating exhibition data including first game medium information related to the first game medium and the first game medium identification information; allowing an exhibition screen generated based on the exhibition data to be displayed in the game being played by the second player; receiving from the second player a bid request including at least the first game medium identification information and the second game medium identification information; generating, based on the bid request, bid data including second game medium information related to the second game medium and not including the second player specifying information; allowing a bid screen generated based on the bid data to be displayed in the game being played by the first player; receiving from the first player an exchange confirmation request including at least the second game medium identification information; and updating the game medium identification information storage unit based on the exchange confirmation request such that the first game medium identification information is stored in association with the second player identification information, and the second game medium identification information is stored in association with the first player identification information.

Various embodiments of the present invention provide a game system that technically restrains real money trade.

### BRIEF DESCRIPTION OF THE DRAWINGS

FIG. 1 is a block diagram schematically illustrating the architecture of a game system according to an embodiment of the present invention.

FIG. 2 is a block diagram schematically illustrating the architecture of a terminal device 30 according to an embodiment of the present invention.

FIG. 3 is a block diagram illustrating the functionality of the server device 10 according to the embodiment of the present invention.

FIG. 4 shows an example of game medium identification information table stored on a game medium identification information storage unit 52.

FIG. 5 shows an example of exhibition request management table.

FIG. 6 shows an example of player specifying information table.

FIG. 7 shows an example of search screen for searching game media.

FIG. 8 shows an example of exhibition screen.

FIG. 9 shows an example of selection screen for bid game media.

FIG. 10 shows an example of bid screen on a terminal device of an exhibitor player.

FIG. 11 shows an example of updated game media identification information table.

FIGS. 12(a) and 12(b) show examples of group management table.

FIGS. 13(a) and 13(b) show examples of group classification table.

FIG. 14 shows an example of player management table.

### DESCRIPTION OF EXAMPLE EMBODIMENTS

Various embodiments of the present invention will be described hereinafter with reference to the appended drawings. In the drawings, the same components are denoted by the same reference numerals.

FIG. 1 is a block diagram schematically illustrating the architecture of a game system according to an embodiment of the present invention. As illustrated in FIG. 1, an online game server device 10 (hereinafter also referred to simply as the “server device 10”) in accordance with one embodiment may be communicatively connected to a plurality of terminal devices 30-1, 30-2, . . . , and 30-N (hereinafter also collectively referred to as the “terminal device 30” or “terminal devices 30”), each having a communication function, via a communication network 20 such as the Internet. The server device 10 is an example of a game system according to an embodiment of the present invention.

As illustrated in FIG. 1, the server device 10 includes a central processing unit (CPU) 11, a main memory 12, a user interface (I/F) 13, a communication I/F 14, an external memory 15, and a disk drive 16, and these components may be electrically connected to one another via a bus 17. The CPU 11 may load an operating system and various programs for controlling the progress of an online game into the main memory 12 from the external memory 15, and may execute commands included in the loaded programs. The main memory 12 may be used to store a program to be executed by the CPU 11, and may be formed of, for example, a dynamic random access memory (DRAM).

The user I/F 13 includes, for example, an information input device such as a keyboard or a mouse for accepting an input from an operator, and an information output device such as a liquid crystal display for outputting calculation results of the CPU 11. The communication I/F 14 may be implemented as hardware, firmware, or communication software such as a transmission control protocol/Internet protocol (TCP/IP) driver or a point-to-point protocol (PPP) driver, or a combination thereof, and may be configured to be able to communicate with the terminal devices 30 via the communication network 20.

The external memory 15 may be formed of, for example, a magnetic disk drive, and stores various programs such as a game program for allowing the terminal device 30 to execute an online game and a control program for controlling the progress of the online game. The game program may be created using, for example, Adobe Flash™, which is a format developed by Adobe Systems Incorporated to handle moving images, games, and the like. The game program created using Adobe Flash™ may be stored in the external memory 15 as a small web format (SWF) file. The game program will be described below. The disk drive 16 may read data stored in a storage medium such as a compact disc read only memory (CD-ROM), digital versatile disc read only memory (DVD-ROM), or DVD Recordable (DVD-R) disc, or write data to such a storage medium. For example, data of a game program or the like stored in a storage medium may be read by the disk drive 16, and may be installed into the external memory 15.

The terminal device 30 may be any information processing device capable of executing and operating a game program stored on the server device 10 and displayed on a web browser, non-limiting examples of the terminal device 30 including a mobile phone, a smartphone, a game console, a personal computer, a tablet, or an electronic book reader. Additionally, the terminal device 30 may be capable of receiving a game program from the server device 10 through a communication I/F 34 (described later) for executing the game.

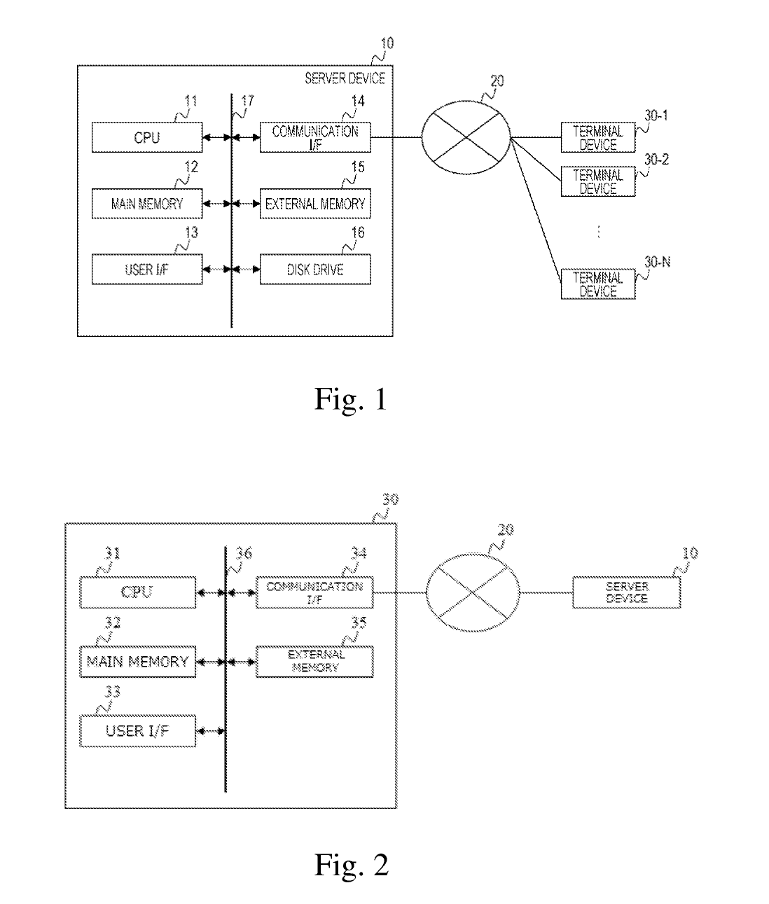

The architecture of these various terminal devices 30 will be described with reference to FIG. 2. FIG. 2 is a block diagram schematically illustrating the architecture of a terminal device 30 according to an embodiment of the present invention. As illustrated in FIG. 2, the terminal device 30 may include a central processing unit (CPU) 31, a main memory 32, a user interface (I/F) 33, a communication I/F 34, and an external memory 35, and these components may be electrically connected to one another via a bus 36.

The CPU 31 may load various programs such as an operating system into the main memory 32 from the external memory 35, and execute commands included in the loaded programs. The main memory 32 may store a program to be executed by the CPU 31, and may be formed of, for example, a dynamic random access memory (DRAM).

The user I/F 33 includes, for example, an information input device such as a touch panel, a keyboard, a button, and a mouse for accepting an input from a player (user), and an information output device such as a liquid crystal display for outputting calculation results of the CPU 31. The communication I/F 34 may be implemented as hardware, firmware, or communication software such as a transmission control protocol/Internet protocol (TCP/IP) driver or a point-to-point protocol (PPP) driver, or a combination thereof, and may be configured to be able to communicate with the server device 10 via the communication network 20.

The external memory 35 comprises, for example, a magnetic disk drive or a flash memory and stores various programs such as an operating system. When receiving a game program from the server device 10 via the communication I/F 34, the external memory 35 may store the received game program.

The terminal device 30 having such architecture may be provided with, for example, browser software for interpreting a hypertext markup language (HTML) file and displaying a screen, and plug-in software (e.g., Flash Player distributed by Adobe Systems Incorporated) incorporated in the browser software. The terminal device 30 may acquire an SWF file embedded in an HTML file from the server device 10, and execute the SWF file using the browser software and plug-in software, and therefore the user of the terminal device 30, or a game player, may be provided with a gaming function.

A game program will be described with reference to FIGS. 1 and 2. The game program may be stored on the external memory 15 of the server device 10 in various forms. For example, the game program may be provided as a piece of application software executable on various application execution platforms. The player may be able to execute or operate a game application using the terminal device 30.

The external memory 15 of the server device 10 may store game programs for executing or operating various games executable or operable on the terminal device 30. The game programs may be created using, for example, script languages such as ActionScript™ and JavaScript™, or object-oriented programming languages such as Objective-C™ and Java™. The game programs may be executed and/or operated on a platform installed on the terminal device 30. A game program to be stored on the external memory 15 may be produced by modifying a web page created in a markup language such as HTML5 by using a style sheet such as Cascading Style Sheet 3 (CSS3). Such a web page created in a markup language may be executed or operated by the browser software installed on the terminal device 30. The external memory 15 of the server device 10 may store a desired number of game programs, and a game program for executing and/or operating a game selected by the terminal device 30 may be provided to a desired number of terminal devices 30 via the communication I/F 14 in accordance with control of the CPU 11. In the terminal device 30, the game program sent from the server device 10 may be transferred to the external memory 35 via the communication I/F 34 in accordance with control of the CPU 31.

The terminal device 30 may execute or operate the game program to play various games such as action games, role-playing games, baseball interactive games, and card games. The games implemented by the game program are not limited to those explicitly disclosed herein. When a game is executed, for example, animation or an operation icon designated by the program may be displayed on a screen of the terminal device 30. The player may enter an instruction for causing the game to progress using an input interface (e.g., a touch screen or a button) of the terminal device 30. The instruction entered by the player may be transmitted to the server device 10 through the browser of the terminal device 30 or a platform function such as ngCore™. The terminal device 30 may send information indicating various parameters (such as the number of game points earned and information concerning obtained items), which is used in the game, and information indicating the status of the game (such as information specifying which mission has been fulfilled) to the server device 10, if necessary. The server device 10 may manage the progress of the individual players in the game in accordance with information received from the plurality of terminal devices 30, such as instructions, information indicating the parameters, and information indicating the statuses. Thus, each player is able to resume the interrupted game from the point where it was interrupted, on the basis of the information concerning the progress of the game held in the server device 10.

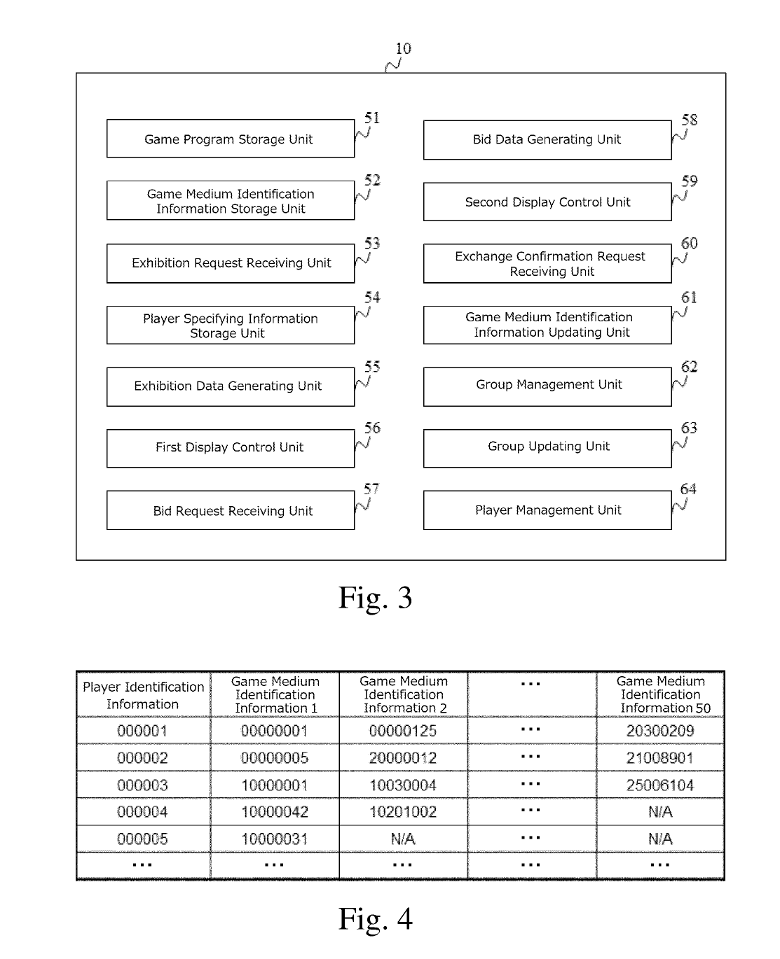

Next, the functionality of the server device 10 implemented by the components shown in FIG. 1 will be further described with reference to FIG. 3. FIG. 3 is a block diagram illustrating the functionality of a server device 10 according to an embodiment of the present invention. As shown in FIG. 3, the server device 10 according to the embodiment may comprise a game program storage unit 51, a game medium identification information storage unit 52, an exhibition request receiving unit 53, a player specifying information storage unit 54, an exhibition data generating unit 55, a first display control unit 56, a bidding request receiving unit 57, a bid data generating unit 58, a second display control unit 59, an exchange confirmation request receiving unit 60, a game medium identification information updating unit 61, a group management unit 62, a group updating unit 63, and a player management unit 64.

As stated above, the game program storage unit 51 may store game programs for executing or operating various games executable or operable on the terminal device 30. A user of the terminal device 30 may obtain game programs stored on the game program storage unit 51 and run the obtained game programs on the terminal device 30, thereby to play the game on the terminal device 30. As stated above, various games may be performed on the terminal device 30. Various game media such as electronic cards, electronic items, and virtual currency may be used in the games performed on the terminal device 30.

The term “game media” may collectively refer to electronic data used by players for progressing the games and including, for example, electronic cards, electronic items, avatars, and virtual currency. In an embodiment of the present invention, the game media may be obtained, owned, used, managed, exchanged, fused, reinforced, sold, discarded, and/or presented by players in the games in accordance with progression of the games; and the use of the game media is not limited to those explicitly described herein. In selling of a card in a game, a player is paid in virtual currency used in the game, not in real currency, for the card sold. A card used as a game medium may have parameters (e.g., “attribute,” “level,” “offensive power,” and “defensive power”) required for the progression of a game. These parameters may be updated as the game progresses. A player can progress the game using the card having updated parameters. A game that uses a card as a game medium may be called a card game. In the card game, a player can use a card to fulfill a mission and combat other players and non-player characters, thereby progressing the game. The Applicant provides various card games on Mobage™ platform.

A player of a game stored on the game program storage unit 51 can obtain and own various game cards in accordance with the progression of the game. The game medium identification information storage unit 52 may store game medium identification information on game media owned by each player in a game medium identification information table, in association with player identification information unique to the player owning the game medium. When the player newly obtains a game medium, the game medium identification information storage unit 52 may store the game medium identification information for identifying the game medium, in association with player identification information unique to the player who obtained the game medium, thereby updating the game medium identification information table.

“Player identification information” may consist of an identification code that identifies a player of a game and is composed of, for example, a six-digit number. The code system of the player identification information is not limited to those explicitly described herein and may be configured desirably. For example, the player identification information may include an alphabetic character. Ordinarily, the player identification information may be assigned to a player when the player first logs in a game, and may be reused for later logins of the player. Thus, the player identification information may be unique to a player and identify the player in a game.

“Game medium identification information” may consist of an identification code that identifies a game medium owned by a player and may be composed of, for example, an eight-digit number. The code system of the game medium identification information is not limited to those explicitly described herein and may be configured desirably. For example, the game medium identification information may include an alphabetic character. When the player obtains a game medium such as a card and an item in a game, the game medium identification information may be generated to uniquely identify the game medium and may be stored in the game medium identification information table in association with the player identification information of the player who obtained the game medium.

FIG. 4 shows an example of game medium identification information table stored on a game medium identification information storage unit 52. As shown, the game medium identification information table included in the game system according to an embodiment of the present invention may store game medium identification information 1 to 50 in association with player identification information. An upper limit may be set for the number of game media that can be owned by each player; FIG. 4 shows an example where each player can own up to 50 game media. In FIG. 4, the player identified by the player identification number “000001” (hereinafter also referred to as “player 1”) owns 50 game media identified by game medium identification information “00000001,” “00000125,” . . . “20300209.” The game medium identification information table shown in FIG. 4 is a mere example; in the present invention, variously altered game medium identification information tables may be used. Further, the game medium identification information storage unit 52 is not necessarily required to store a game medium identification information table, but may manage game medium identification information of a large number of game media used in the game in association with the player identification information of the player owning the game media by using a desired technique known to those skilled in the art.

The game media may be obtained by players as required in accordance with the progression of the game; and thus not all the players own a maximum number of game media. For example, the player identified by the player identification number “000005” (hereinafter “player 5”) owns one game medium identified by the game medium identification information “10000031.” When player 5 obtains a new game medium in the game, game medium identification information identifying the obtained game medium may be newly generated, and the generated game medium identification information may be stored as a record for “game medium identification information 2” in association with the player identification number “000005.”

Further, a player can dispose of his own game media by discarding, selling, etc. For example, player 1 can discard a game medium identified by the game medium identification information “20300209.” When an instruction to discard the game medium identified by the game medium identification information “20300209” is issued, data indicating the game medium identification information “20300209” may be deleted from “game medium identification information 50” of player 1. When player 1 obtains a new game medium after discarding the game medium identified by “20300209,” game medium identification information identifying the newly obtained game medium may be stored as a record for “game medium identification information 50” in association with the player identification number “000001.”

Thus, the game medium identification information storage unit 52 may store game medium identification information unique to a game medium in association with player identification information unique to the player owning the game medium. As stated above, the association between game medium identification information and player identification information can be altered as necessary when the player obtains, sells, or discards a game medium. The game medium identification information storage unit 52 may store game medium identification information unique to a game medium in “dynamic” association with player identification information unique to the player, so that the change of an owner of a game medium may be reflected. That is, when the player owning a game medium is changed, the association between the game medium identification information of the game medium and the player identification information may be altered so that the change of the player owning the game medium may be reflected. By way of an example, game media can be exchanged between players. The association between the game medium identification information and the player identification information in the game medium identification information storage unit 52 may be altered so that the changes of the players owning the game media caused by the exchange may be reflected.

Following is an example of a method of exchanging game media between players in a game. When a player is to exchange a game medium for another game medium owned by another player, the player may operate a terminal device 30 performing the game to send an exhibition request to the server device 10 so as to exchange the player's own game medium for the game medium of the other player.

The exhibition request may include various information such as player identification information of the player making an exhibition request (hereinafter also referred to as an exhibitor player“), game medium identification information of the game medium to be exhibited for exchange (hereinafter also referred to as an exhibited game medium”), and desired conditions for a desired game medium to be obtained in exchange for the exhibited game medium. For example, player 1 can exhibit a game medium identified by the game medium identification information “00000125” out of the player's own game media, for exchange for another game medium. In this case, player 1 can send to the server device 10 an exhibition request specifying a game medium corresponding to the game medium identification information “00000125” by using a user interface provided by the terminal device 30. The exhibition request may include, for example, the player identification information “000001” of player 1 (an exhibitor player) and the game medium identification information “00000125” of the exhibited game medium. Also, the exhibition request may include desired conditions for the desired game medium. The desired conditions may include, for example, at least part of various information representing the type and quantity of cards and items, attributes of cards such as offensive power, and attributes of game media such as amount of virtual currency. In an embodiment, desired conditions are desirably inputted by an exhibitor player. For example, if the desired conditions include the number of desired game media, the exhibitor player can input a desired number such as 127. In another embodiment, the desired conditions may be selected from a limited number of options presented by the game. For example, when the desired conditions include the number of desired game media, 10-increment options ranging from 10 to 200 such as “10,” “20,” . . . “200” may be presented, and the exhibitor player may select one close to the desired condition from the limited number of options.

The exhibition request sent from the terminal device 30 may be received by the server device 10. The received exhibition request may be received by an exhibition request receiving unit 53. In an embodiment, when receiving an exhibition request, the exhibition request receiving unit 53 may generate exhibition request identification information unique to the exhibition request and store at least part of information included in the exhibition request in association with the exhibition request identification information.

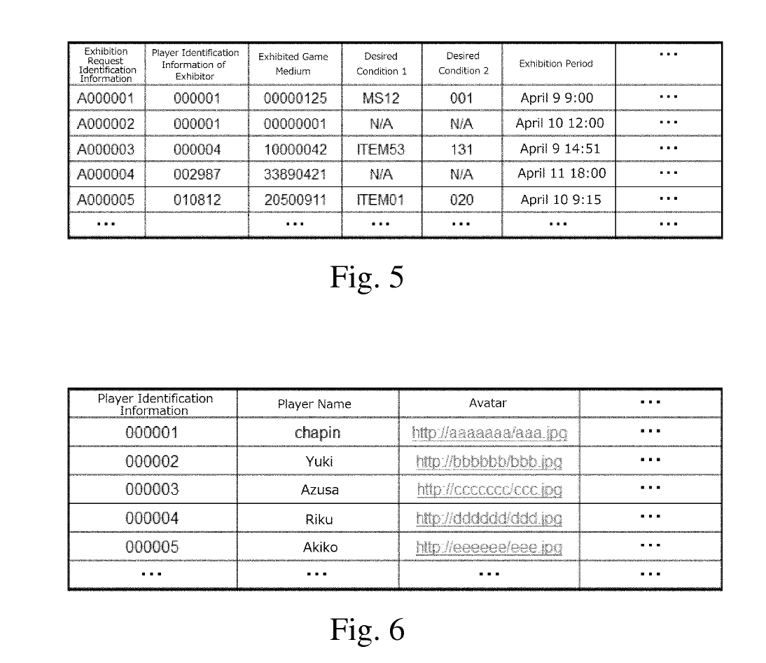

FIG. 5 shows an example of an exhibition request management table that is created, updated, and managed by the exhibition request receiving unit 53. As shown, the exhibition request management table may store player identification information of an exhibitor player, game medium identification information of an exhibited game medium, a plurality of desired conditions, and an exhibition period representing the duration of the exhibition, for each exhibition request received by the exhibition request receiving unit 53. In the example shown in FIG. 5, the exhibition request identification information “A000001” may be generated on reception of an exhibition request from player 1, and the exhibition request management table may store the player identification information “000001” of player 1, the game medium identification information “00000125” included in the received exhibition request, the desired conditions “MS12” and “001,” and information representing the date and time “4/9 9:00” when the exhibition of the exhibited game medium is to be terminated, in association with the exhibition request identification information “A000001.” For example, the exhibition period may be set to 24 hours after the exhibition request is received from the exhibitor player.

As stated above, various conditions for desired game media can be set by the exhibitor player as desired conditions. In the example shown in FIG. 5, Condition 1 may be set to “MS12” representing the type of the desired game media, and Condition 2 may be set to “001” representing the number of the desired game media. That is, the exhibition request identified by the exhibition request identification information “A000001” may indicate that player 1 identified by the player identification information “000001” wants to obtain one game medium of the type identified by “MS12.” The setting of desired conditions is optional, and desired conditions may not be set. For example, the exhibition request identification information “A000004” is an example of a record created based on an exhibition request in which desired conditions are not inputted by the exhibitor player, and thus it contains no data representing the desired conditions in the columns Desired Condition 1 and Desired Condition 2.

The server device 10 may store various information for progression of the game, in addition to information on game media. For example, the player specifying information storage unit 54 may store, for each player, player specifying information that specifies the player. The “player specifying information” may consist of any information that represents personality and characteristics of a player and specify the player when presented to another player. In games, a display image representing a player may be generated based on the player specifying information, and the display image may be displayed in the game screen of another player to communicate the personality and the characteristics of the player to the other player. The display images representing the players may express the personalities of players, thereby encouraging interaction between players through the game.

The player specifying information may include, for example, player attribute information set by the player to characterize the player, such as a player name or avatar. The player name may be desirably determined by the player; therefore, a plurality of players possibly uses the same player name. Accordingly, a player name does not uniquely specify a player, but practically it serves as an indicator for specifying a player because the number of players interactively playing a game is limited in terms of time. Accordingly, a player name is herein included in player specifying information that specifies a player. An avatar is also included in player specifying information for the same reason. That is, many players play games using avatars having distinctive appearance to express their personalities. To support such needs of players, various items for decorating avatars may be provided as a function of games or a platform of games. Accordingly, an avatar cannot always uniquely specify a player but serves for specifying a player.

The player specifying information storage unit 54 may generate and manage, for example, a player specifying information table illustrated in FIG. 6. The player specifying information table in FIG. 6 may manage various player specifying information such as player names and avatars in association with player identification information of each player. Avatars may be stored as, for example, images in JPEG format on the server device 10; the player specifying information management table may manage URLs indicating the location where the images are stored.

The player specifying information may include various information occurring in progression of games, in addition to player attribute information desirably set by players such as user names and avatars. For example, the player specifying information may include exhibition request identification information that specifies exhibition request identification information generated based on an exhibition request and thereby uniquely specifies an exhibitor player. Also, the player specifying information may include player identification information that specifies a player.

The processing of exhibition request in the server device 10 will be further described. The exhibition data generating unit 55 may refer to the exhibition request management table and generate exhibition data including game medium information related to an exhibited game medium for each exhibition request received by the exhibition request receiving unit 53. The exhibition data may include game medium identification information that identifies the exhibited game medium. As will be described below, the generated exhibition data may be displayed in a display screen on the terminal device 30 as part of a game screen when the game is played on the terminal device 30, and thereby communicated to the player of the game. The “game medium information” related to a game medium may include an image representing the game medium, the name of the game medium, and various parameters of the game medium such as the level and offensive power. The game medium information is not limited to those explicitly described herein but may include various information representing characteristics and attributes of the game medium. The exhibition data generating unit 55 may generate exhibition data in response to, for example, an exhibition data display request from the player and a search request for exhibited game media satisfying specific conditions. The generated exhibition data may be presented to each player under control of the first display control unit 56 described below.

For example, the exhibition data generating unit 55 may generate exhibition data for an exhibition request identified by the exhibition request identification information “A000001” stored in the exhibition request management table in FIG. 5. The exhibition data for the exhibition request identification information “A000001” may include an image representing an exhibited game medium identified by the game medium identification information “00000125” associated with the exhibition request identification information “A000001,” game medium information such as parameters of the exhibition game medium, and the game medium identification information “00000125.”

In an embodiment, the exhibition data generating unit 55 may generate exhibition data that does not include player specifying information. The exhibition request management table in FIG. 5 may include player specifying information such as player identification information of an exhibitor player and exhibition request identification information. In an embodiment, the exhibition data generating unit 55 may generate exhibition data that does not include these player specifying information. Also, in an embodiment, the exhibition data generating unit 55 may generate exhibition data that does not include player specifying information, such as player name, avatar, and player identification information, that is managed in tables other than the exhibition request management table.

The first display control unit 56 may provide exhibition data generated by the exhibition data generating unit 55 in response to a request from the player. The player playing a game can send a display request for exhibition data to the server device 10, through operation of the terminal device 30 performing the game. The first display control unit 56 may send exhibition data to the game being performed on the terminal device 30 which sent the request, so that an exhibition screen generated based on the exhibition data may be displayed, for example, as part of a display screen of the game.

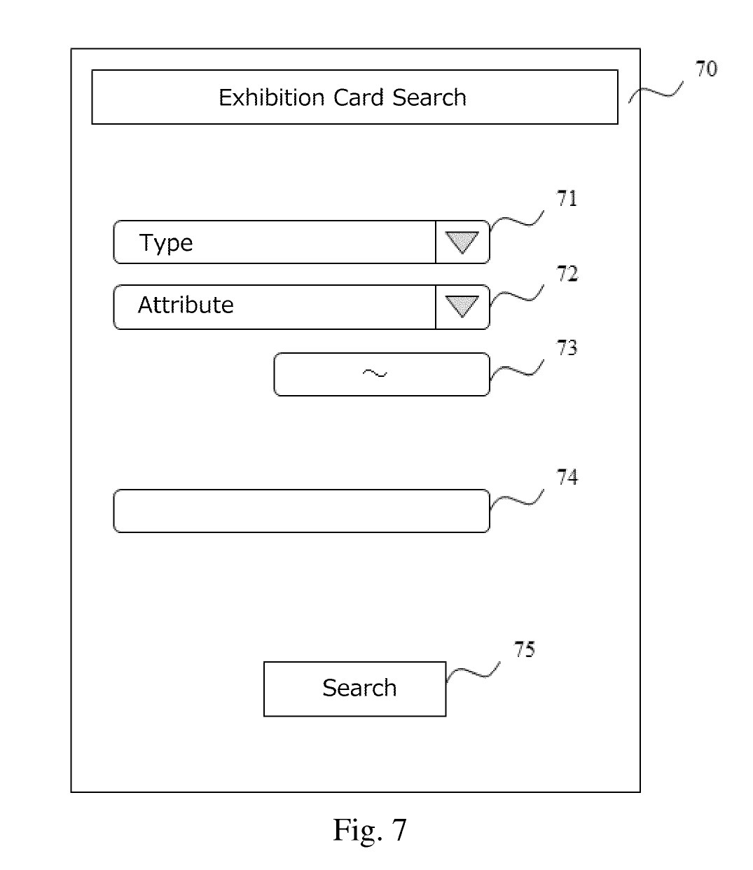

The display request for exhibition data will be further described. For example, a player playing a game can request display of exhibition data by using a search function for searching exhibited game media provided as a function of the game. FIG. 7 shows an example of search screen for searching game media provided as part of functions of the game. For example, the player playing the game can cause the display screen shown in FIG. 7 to be displayed on a display screen of the terminal device 30 performing the game by operating a link or operation button captioned “Exhibition Card Search” displayed in the game screen.

As shown, the search display screen 70 may contain pulldown boxes 71, 72 for designating search conditions, an input box 73 for designating numeric range, an input box 74 for designating a search term, and a Search button 75 for running a search. In a display screen 70 displayed during a game play, a player can operate the pulldown boxes 71, 72 to select search conditions from those preset, input a numeric range and a search term to the input boxes 73, 74, and then operate the Search button 75, thereby sending a search request corresponding to the designated search conditions to the server device 10 through a communication function of the terminal device 30. For example, the pulldown box 71 may provide options representing the types of game media such as “machine,” “vehicle,” and “character”; and the pulldown box 72 may provide options representing parameters of game media such as “offensive power,” “defensive power,” and “mobility.” The input box 73 may accept free input of the player not exceeding a predetermined data amount (in this case, the player can desirably input numerals such as “1231” or text) or provide a limited number of options (e.g., 10-increment options ranging from 10 to 200 such as “10,” “20,” . . . “200”).

For example, the player can select “machine” from the pulldown box 71, select “mobile power” from the pulldown box 82, and input “100-200” to the input box 73 (or select “100-200” from the options provided by the input box 73), and then operate the Search button 75, thereby sending to the server device 10 a search request for searching for “game media having mobile power of ‘100-200’ and classified in the type of ‘machine.’” Upon receiving the search request, the server device 10 may refer to the exhibition request management table and other tables to specify, from the cards being exhibited, exhibited game media satisfying the search conditions designated in the search request. The first display control unit 56 may obtain, from the exhibition data generating unit 55, exhibition data generated for the specified exhibited game media, and return search result information including the obtained exhibition data to the terminal device 30 which sent the search request.

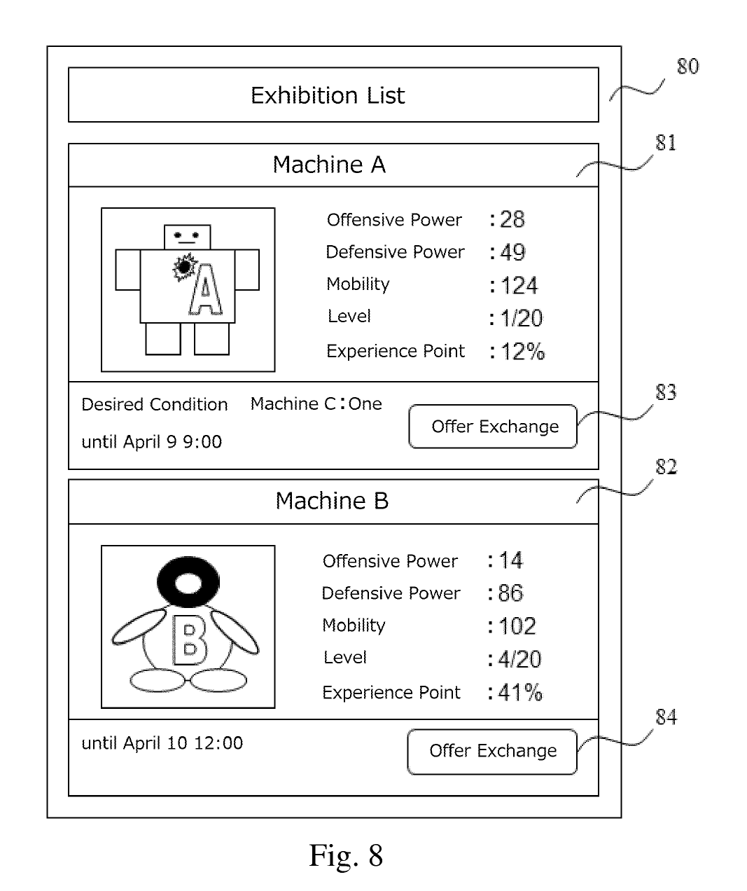

FIG. 8 is an example of display of search result information returned from the server device 10. Specifically, FIG. 8 shows an example of display of search result corresponding to a search request for searching for “game media having mobile power of ‘100-200’ and classified in the type of ‘machine’” with reference to the exhibition request management table shown in FIG. 5. The first display control unit 56 may refer to the exhibition request management table to specify exhibited game media associated with exhibition request identification information “A000001” and “A000002” that satisfy the search condition for “game media having mobile power of ‘100-200’ and classified in the type of ‘machine.’” The first display control unit 56 may obtain, from the exhibition data generating unit 55, exhibition data generated for the exhibited game media associated with exhibition request identification information “A000001” and “A000002,” generate search result information including the two exhibition data, and return the search result information to the terminal device 30 which sent the search request.

The terminal device 30 performing the game may receive the search result information including one or more exhibition data from the first display control unit 56 and perform a drawing process such as rendering based on the received search result information to generate a display screen. The display screen generated based on information including exhibition data is also herein referred to as “an exhibition screen.” The generated exhibition screen may be displayed on the display screen of the terminal device 30. That is, the display screen 80 shown in FIG. 8 is an example of an exhibition screen.

As shown in FIG. 8, the display screen 80 of the terminal device 30 may contain an exhibition data display image 81 and an exhibition data display image 82 representing respective exhibition data. The exhibition data display image 81 is an example of exhibition data for the exhibited game medium associated with the exhibition request identification information included in the search result information identified by “A000001”; the exhibition data display image 82 is an example of exhibition data for the exhibited game medium associated with the exhibition request identification information identified by “A000002.” As shown, the exhibition data display image 81 may represent an exhibited game medium whose “name” is “machine A,” “offensive power” is “28,” and defensive power is “49,” “mobile power” is “124,” “level” is “1,” and “experience point” is “12%.” The exhibition data display image 82 may likewise represent an exhibited game medium having various parameters.

The exhibition data display image may include various information based on the exhibition data, in addition to the parameters of the exhibited game medium. For example, since the exhibition request identification information “A000001” has desired conditions “MS12” and “001,” the exhibition data display image 81 corresponding to the exhibition request identification information “A000001” may contain, in the display area of desired conditions, “machine C” corresponding to “MS12” and one corresponding to “001.” Additionally, the generated exhibition data may include the exhibition period included in the exhibition request management table shown in FIG. 5, so that the exhibition period can be displayed as part of the exhibition data display image. For example, since the exhibition request identification information “A000001” is associated with an exhibition period “4/9 9:00,” the exhibition data display image 81 may contain “until April 9 9:00” in the display area of exhibition period.

In an embodiment, data read from the exhibition request management table may be altered before it is displayed as an exhibition data display image. For example, since the desired conditions may be freely inputted by the exhibitor player, it is likely that a desired condition consisting of unnatural information may be maliciously used as a sign for identifying an exhibitor player. Such examples may include the exhibition request identification information “A000003” in FIG. 5 having Desired Condition 2 set to “131.” In an embodiment, the exhibition data generating unit 55, therefore, may perform rounding to alter input information such as desired conditions freely inputted by the exhibitor player, thereby to generate exhibition data based at least in part on the input information by using the altered input information; thus, the input information becomes useless as a sign. For example, if the Desired Condition 2 is set to “131,” it can be rounded to “150” by 50-increment rounding or to “100” by 100-increment rounding. When rounding is performed on “50”-increment basis, the exhibition data display image may contain “150” instead of “131” in the display area of desired conditions. Thus, the desired condition is prevented from serving as a sign.

Additionally, the exhibition period read from the exhibition request management table may be likewise altered by rounding to generate exhibition data by using the altered exhibition period, so that an exhibitor player cannot be specified based on the exhibition period as with the desired conditions. For example, the exhibition request identification information “A000003” in FIG. 5 has Exhibition Period set to “4/9 14:51.” If “4/9 14:51” is displayed unchanged, “4/9 14:51” is communicated from the exhibitor player to other players to enable specifying the exhibitor player. Alternatively, if this exhibition period is altered to a rounded time such as “4/9 15:00,” the exhibition player is prevented from being specified based on the exhibition period.

On viewing the exhibition screen as shown in FIG. 8, a player can operate the terminal device 30 to select an exhibition data display image representing a desired game medium from the exhibition screen, and send to the server device 10 a bid request for requesting exchange of the player's own game medium for the selected game medium. For example, when the player operates an operation button 83 captioned “Offer Exchange” displayed as part of the exhibition data display image 81, a bid request may be sent to the server device 10 to bid for the game medium corresponding to the exhibition data display image 81, via functions of game programs and the terminal device 30. The player who performs operations to send a bid request based on the display of the exhibition screen may be herein referred to as “a bidder player.” A bidder player may operate the operation button 84 instead of the operation button 83 if it is preferable to exchange for the exhibited game medium corresponding to the exhibition data display image 82.

A bid request may include a first game medium identification information that identifies a desired exhibited game medium, and a second game medium identification information that identifies a game medium to be exchanged owned by the bidder player (which may be herein referred to as “a bid game medium”). A bid request may include player identification information of the bidder player, in addition to the above information. When player 5 is to exchange his own game medium identified by the game medium identification information “10000031” for the exhibited game medium represented by the exhibition data display image 81 included in the exhibition screen, the bid request may include the game medium identification information “00000125” that identifies the exhibition data display image 81, the game medium identification information “10000031” of the game medium to be exchanged, and the player identification information “000005” of player 5. The game medium identification information of the exhibition data display image 81 may be automatically included in the bid request through the function of the software implemented in the terminal device 30 when, for example, the operation button 83 captioned “Offer Exchange” as part of the exhibition data display image 81 is selected.

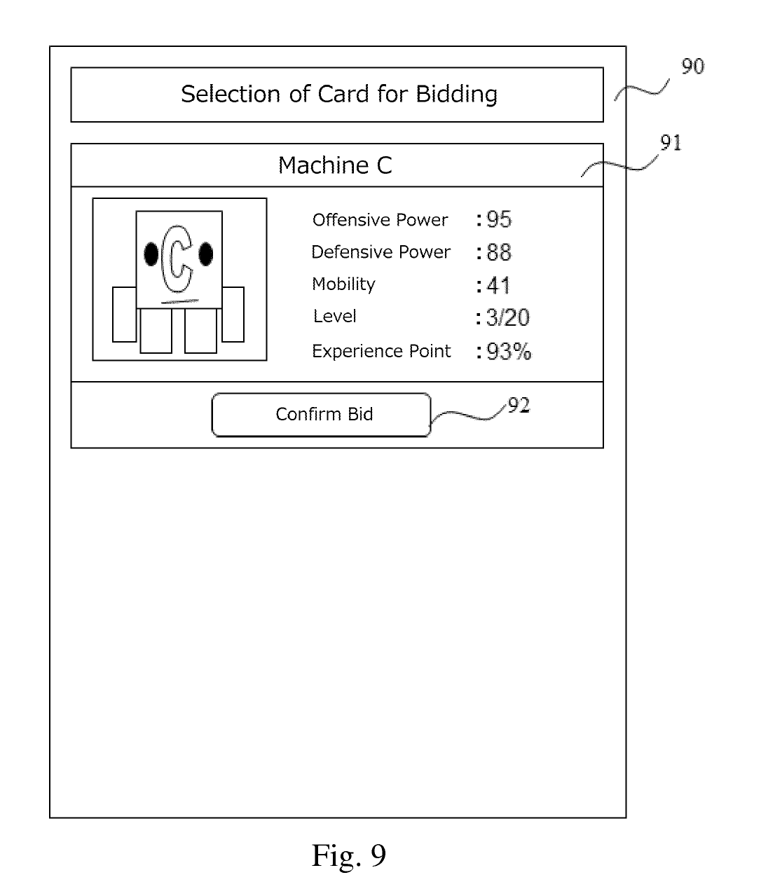

To encourage the bidder player to select a bid game medium, the terminal device 30 may display, for example, a selection screen 90 of bid game media as shown in FIG. 9 in accordance with an instruction from game programs. The selection screen 90 may be displayed on the terminal device 30 upon, for example, operation of the operation button 83 shown in FIG. 8. The selection screen 90 may contain a bid game medium display image 91 representing a game medium owned by the bidder player. FIG. 9 shows an example containing only one bid game medium display image 91; but the selection screen 90 may contain a number of bid game medium display images, the number corresponding to the number of game media owned by the bidder player. The bid game medium display image 91 may include an operation button 92 captioned “Confirm Bid” The bidder player operates the operation button 92, so that the game medium corresponding to the bid game medium display image 91 may be automatically included in a bid request as the second game medium identification information through the function of game programs and the terminal device 30.

As is obvious from FIG. 8, the display screen 80 representing an exhibition screen does not contain player specifying information that specifies the exhibitor player; the bidder player can obtain information on the exhibited game media from the display screen 80 but cannot obtain information that specifies the exhibitor. Further, when an exhibition screen is displayed to the exhibitor player instead of a bidder player, the exhibition screen may contain player specifying information that specifies the exhibitor player. That is, the player specifying information that specifies the exhibitor player is hidden from bidder players or potential bidder players other than the exhibitor player.

The bid request sent from the terminal device 30 of a bidder player may be received by the server device 10. The received bid request may be received by a bid request receiving unit 57 of the server device 10.

The bid data generating unit 58 may generate bid data based on the bid request received by the bid request receiving unit 57. More specifically, the bid data generating unit 58 may extract the second game medium identification information from the received bid request, and generate bid data that includes game medium information related to the bid game medium identified by the second game medium identification information. As already described for exhibition data, game medium information may include various information representing the characteristics of the game medium such as an image associated with the game medium, the name of the game medium, and parameters of the game medium such as level and offensive power.

In an embodiment, the bid data generating unit 58 may generate bid data that does not include player specifying information that could specify the bidder player. The bid data generating unit 58 can generate data that does not include player specifying information in the same manner as the exhibition data generating unit 55.

The second display control unit 59 may provide the exhibitor player with bid data generated by the bid data generating unit 58 in response to a request from the exhibitor player. When playing the game using the terminal device 30, the exhibitor player can send a bid data display request to the server device 10 by using the function of the game. For example, the exhibitor player can select an operation button or a link captioned “Check Exhibited Cards” displayed in the game screen, thereby to request the server device 10 to display bid data. In response to this request, the second display control unit 59 may send bid data to the game being performed on the terminal device 30, so that a bid screen generated based on the bid data may be displayed, for example, as part of a display screen of the game.

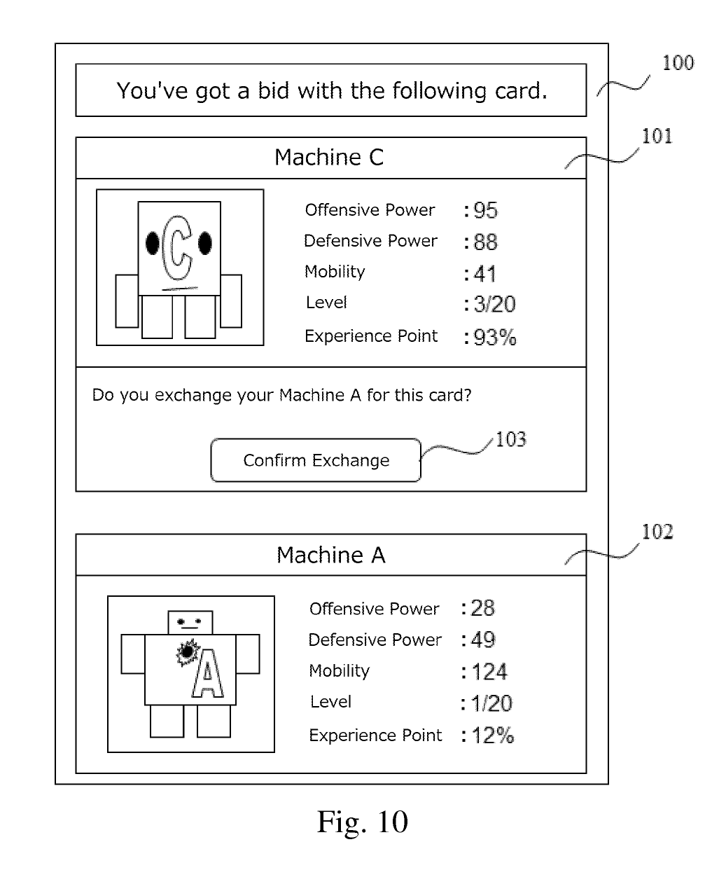

FIG. 10 shows an example of bid screen on a terminal device 30 of an exhibitor player. As shown, the terminal device 30 of the exhibitor player may render received bid data to generate a display screen 100 and display the generated display screen 100 on the display screen of the terminal device 30 as part of the game screen. The display screen 100 is an example of bid screen. As shown, the display screen 100 may contain a bid game medium display image 101 representing a bid game medium specified by the bidder player, and an exhibition data display image 102 representing the exhibited game medium exhibited by the exhibitor player. The exhibitor player can grasp from the display screen 100 that another player (a bidder player) has offered exchanging of the exhibited game medium represented by the exhibition data display image 102 for the game medium represented by the bid game medium display image 101. The exhibitor player can select the operation button 103 displayed as part of the bid game medium display image 101, thereby to exchange his own exhibited game medium for the bid game medium corresponding to the bid game medium display image 101. More specifically, when an operation button 103 is operated, an exchange confirmation request may be generated and sent to the server device 10 through the function of the game programs and the terminal device 30. The exchange confirmation request may include the game medium identification information of both game media to be exchanged (the bid game medium corresponding to the bid game medium display image 101 and the exhibited game medium corresponding to the exhibition data display image 102).

The exchange confirmation request may be received by the server device 10. The received exchange confirmation request may be received by an exchange confirmation request receiving unit 60.

Based on the exchange confirmation request received by the exchange confirmation request receiving unit 60, the game medium identification information updating unit 61 may update the game medium identification information table stored on the game medium identification information storage unit 52. More specifically, the game medium identification information updating unit 61 may specify the exhibited game medium and the bid game medium that are exchanged, based on the exchange confirmation request, and update the association between the exhibited game medium and the player identification information and the association between the bid game medium and the player identification information in the game medium identification information table. For example, in the case where an exhibited game medium of player 1 represented by the game medium identification information “00000125” and a bid game medium of player 5 represented by the game medium identification information “10000031” are exchanged, the game medium identification information “00000125” corresponding to the exhibited game medium that is not owned by player 1 after the confirmation of the exchange may be deleted from the column of Game Medium Identification Information 2 associated with the player identification information “000001” of player 1, and instead, the game medium identification information “10000031” corresponding to the bid game medium obtained through the exchange may be stored in the column. Meanwhile, the game medium identification information “10000031” corresponding to the bid game medium that is not owned by player 5 after the confirmation of the exchange may be deleted from the column of Game Medium Identification Information 1 associated with the player identification information “000005” of player 5, and instead, the game medium identification information “00000125” corresponding to the exhibited game medium obtained through the exchange may be stored in the column.

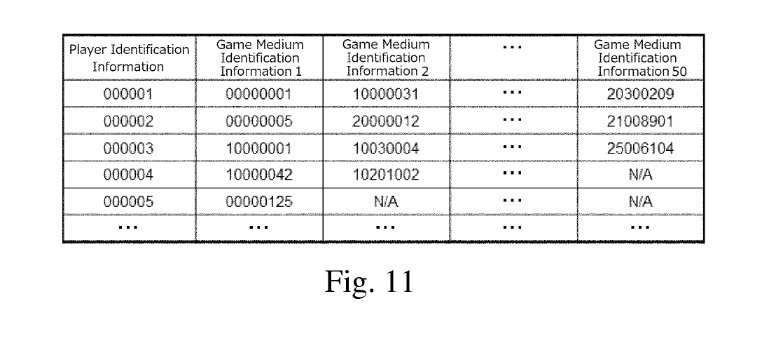

Thus, the game medium identification information table may be updated so that the bid game medium originally owned by player 5 may be associated with the player identification information of player 1, and the exhibited game medium originally owned by player 1 may be associated with the player identification information of player 5. FIG. 11 shows the updated game media identification information table. Thus, the exchange of the exhibited game medium of player 1 and the bid game medium of player 5 is complete. After the exchange, player 1 can play the game using the game medium represented by the game medium identification information “10000031,” and player 5 can play the game using the game medium represented by the game medium identification information “00000125.”

As stated above, in an embodiment of the present invention, the information on the exhibited game medium of the exhibitor player may be presented to the bidder player so that the presented information does not include the player specifying information that specifies the exhibitor player. Thus, in the sequential process of exchanging game media in a game, a bidder player cannot specify the exhibitor player. In online games, identical or similar game media may be exhibited by multiple players; and, even if players previously agree outside the game on payment of real currency in expense of exchanged game media, the partner of trading outside the game cannot be specified in the game where player identification information is hidden. Thus, if a function of preventing a partner of exchange of game media from being specified is implemented in a game, the function inhibits trading in reality. Accordingly, a game system according to an embodiment of the present invention technically restrains real money trade.

Further, in another embodiment of the present invention, the information on the bid game medium of the bidder player may be presented to the exhibitor player so that the presented information does not include the player specifying information that specifies the bidder player. Thus, the exhibitor player cannot specify the bidder player in the game. Accordingly, trading in reality is inhibited as with the above example wherein the exhibitor player is prevented from being specified. Thus, a game system according to the other embodiment of the present invention also technically restrains real money trade.

In still another embodiment of the present invention, the information on the exhibited game medium of the exhibitor player may be presented to the bidder player so that the presented information does not include the player specifying information that specifies the exhibitor player, while the information on the bid game medium of the bidder player may be presented to the exhibitor player so that the presented information does not include the player specifying information that specifies the bidder player. This embodiment further inhibits the partner of exchange of game cards in a game from being specified, thus effectively restraining real money trade.

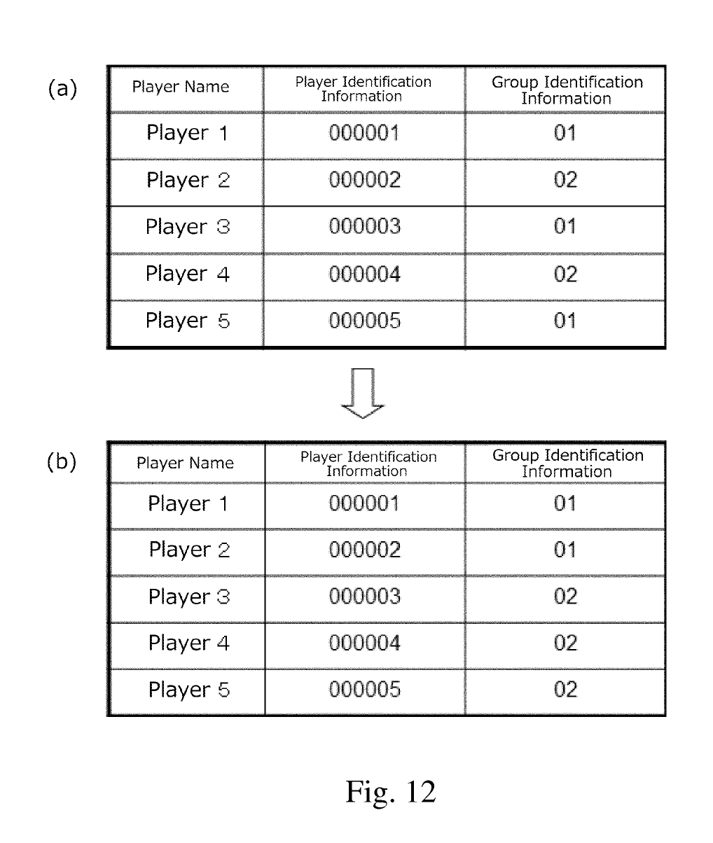

In another embodiment of the present invention, the server device 10 may further comprise a group management unit 62. The group management unit 62 may randomly group players of a game into a plurality of groups. For example, the group management unit 62 may manage groups of players with a group management table as shown in FIGS. 12(a) and 12(b). FIGS. 12(a) and 12(b) shows an example of group management table for managing groups of players of a game. In FIG. 12(a), player 1, player 3, and player 5 are grouped in the first group represented by the group identification information “01,” while player 2 and player 4 are grouped in the second group represented by the group identification information “02.”

The group updating unit 63 may regularly or irregularly alter the grouping of the players in accordance with a certain algorithm. FIG. 12(b) shows an example of the group management table after the grouping is altered. In FIG. 12(b), player 1 and player 2 are grouped in the first group represented by the group identification information “01,” while player 3, player 4, and player 5 are grouped in the second group represented by the group identification information “02.”

In the embodiment, the first display control unit 56 may allow display of an exhibition screen only to players grouped in the same group as the exhibitor player. Supposing that player 1 exhibits a game medium when players are grouped as shown in FIG. 12(a), the exhibition screen related to the exhibited game medium of player 1 can be displayed in the game screens of player 3 and player 5 in response to the requests from player 3 and player 5, but it cannot be displayed in the game screens of player 2 and player 4. For example, even if the game medium exhibited by player 1 satisfies the search conditions provided by player 2, the information on the exhibited game medium of player 1 may not be displayed in the game screen of player 2.

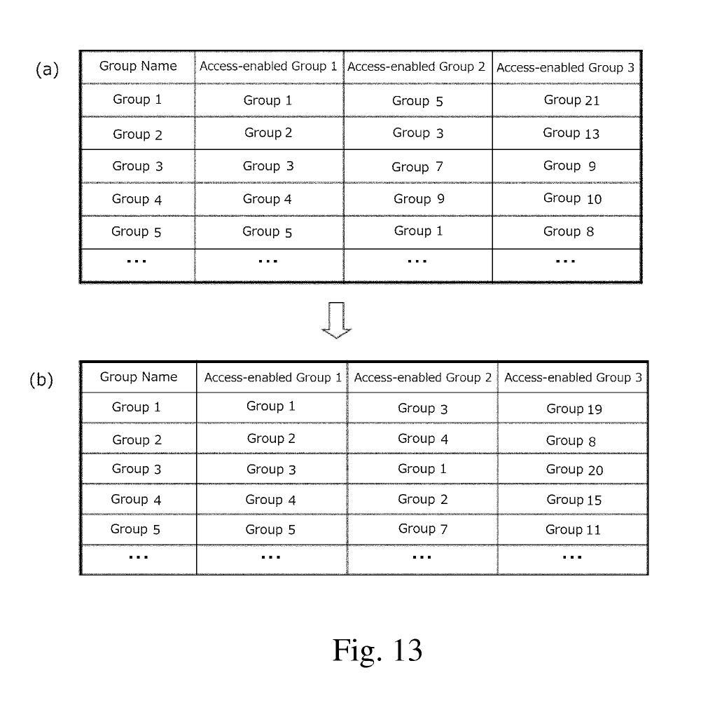

Further, the group management unit 62 may manage a plurality of groups for players in association with each other. For example, the group management unit 62 may associates a plurality of groups with each other by using a group classification table as shown in FIGS. 13(a) and 13(b). The purpose of such association of groups is, for example, to limit the players allowed to obtain, access, or browse exhibition data. For example, in the example shown in FIG. 13(a), group 1 is associated with groups 1, 5, and 21. In this case, the exhibition data related to a game medium exhibited by a player in group 1 can be obtained and accessed by players in groups 1, 5, and 21 but cannot be obtained or accessed by players in other groups. Herein, a group allowed to obtain and access the exhibition data from a player in a certain group may be referred to as an access-enabled group. The first display control unit 56 may allow display of an exhibition screen related to an exhibited game medium exhibited by an exhibitor player only to players in groups associated with the group including the exhibitor player as an access-enabled group. For example, if the exhibitor player is in group 1, the exhibition screen may be displayed only to players in groups 1, 5, and 21.

The group updating unit 63 may regularly or irregularly alter the association of the groups in accordance with a certain algorithm. FIG. 13(b) shows an example of the group classification table after the association is altered. In the example shown in FIG. 13(b), access-enabled group 1 remains unchanged, while access-enabled groups 2 and 3 are changed. Thus, access-enabled groups may be changed partially. As is obvious from FIGS. 13(a) and 13(b), in an embodiment of the present invention, a group can be fixed as an access-enabled group with respect to the same group. That is, group 1 can be fixedly set as an access-enabled group with respect to group 1. Thus, exhibition data can be provided to players in the same group by fixing the group as an access-enabled group with respect to the same group. As stated above with reference to FIGS. 12(a) and 12(b), an exhibition screen can be controlled to be displayed only to players in the same group as the exhibitor player. Such an example shown in FIGS. 12(a) and 12(b) can be regarded as an example of the embodiment shown in FIGS. 13(a) and 13(b) wherein a certain group is set as the access-enabled group with respect to the same group.

Thus, even if players agree in reality on payment of real currency in expense of exchanged game media, game media cannot be exchanged in games between the players in different groups in the game. Since the grouping is randomly performed in accordance with a predetermined algorithm, a player cannot determine whether a trade partner in reality is in the same group. Thus, players are randomly grouped and game media can be exchanged only between players in the same group, thereby inhibiting implementation of a trade in reality to restrain real money trades.

Further, grouping of players can be altered to conceal the grouping even after a player specifies his own group. Additionally, access-enabled groups can be altered to conceal access-enabled groups. Thus, real money trade can be effectively restrained.

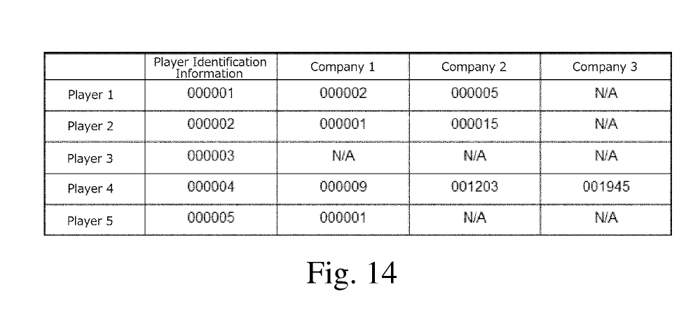

In another embodiment of the present invention, the server device 10 may further comprise a player management unit 64. The player management unit 64 can store player identification information on players of the games dynamically associated with player identification information on other players in, for example, the player management table shown in FIG. 14. For example, a player can register other players as “companies.” The players registered as “companies” can cooperate with each other to progress a game. “A company” is registered when an offer from one player to another player is accepted. It can also be canceled when any of the players performs the processing for canceling the registration of the “company.”

In the embodiment, the first display control unit 56 may allow display of an exhibition screen only to players registered as “companies” of the exhibitor player. For example, when player 1 having registered “companies” as shown in FIG. 14 exhibits a game medium, the exhibition screen related to the exhibited game medium of player 1 may be displayed only in games played by players 2 and 5 who are companies of player 1. Meanwhile, the exhibition screen related to the exhibited game medium of player 1 may not be displayed in games played by players 3 and 5.

Thus, even if players agree in reality on payment of real currency in expense of exchanged game media, game media cannot be exchanged in games between the players not registered as “companies” in the game. Since the maximum number of “companies” registrable is usually limited, it is unlikely that “companies” are registered only to trade game media. Thus, game media are exchanged only between players registered as “companies,” thereby inhibiting implementation of a trade in reality to restrain real money trades.

The processes and procedures described and illustrated herein may be implemented by software, hardware, or any combination thereof, as well as that explicitly stated in the embodiments. More specifically, the processes and procedures described and illustrated herein may be implemented by the installation of the logic corresponding to the processes into a medium such as an integrated circuit, a volatile memory, a non-volatile memory, a magnetic disk, or an optical storage. The processes and procedures described and illustrated herein may also be installed in the form of a computer program, and executed by various computers.

The processes and procedures described and illustrated herein to be executed by a single device, software piece, component, or module may also be executed by a plurality of devices, software pieces, components, and/or modules. The data, table, or database described and illustrated herein to be stored in a single memory may also be distributed to and stored in a plurality of memories included in a single device or a plurality of memories which are located in a plurality of devices in a distributed manner. Furthermore, the elements of the software and hardware elements described and illustrated herein may also be integrated into a smaller number of constituent elements or separated into a larger number of constituent elements.

What is claimed is:

1. A game system comprising:
a game program storage unit configured to store a game program for performing a game on a terminal device;
a game medium identification information storage unit configured to store first game medium identification information unique to a first game medium for use in the game and second game medium identification information unique to a second game medium for use in the game, wherein the first game medium identification information is stored in association with first player identification information unique to a first player owning the first game medium, and wherein the second game medium identification information is stored in association with second player identification information unique to a second player owning the second game medium;
a player specifying information storage unit configured to store first player specifying information capable of specifying the first player and second player specifying information capable of specifying the second player;
an exhibition data generating unit configured to generate exhibition data including first game medium information related to the first game medium and the first game medium identification information;
a first display control unit configured to allow an exhibition screen generated based on the exhibition data to be displayed in the game being played by the second player;
a bid request receiving unit configured to receive from the second player a bid request including at least the first game medium identification information and the second game medium identification information;
a bid data generating unit configured to generate, based on the bid request, bid data including second game medium information related to the second game medium and not including the second player specifying information;
a second display control unit configured to allow a bid screen generated based on the bid data to be displayed in the game being played by the first player;
an exchange confirmation request receiving unit configured to receive from the first player an exchange confirmation request including at least the second game medium identification information; and
a game medium identification information updating unit configured to update the game medium identification information storage unit based on the exchange confirmation request such that the first game medium identification information is stored in association with the second player identification information, and the second game medium identification information is stored in association with the first player identification information.

2. The game system of claim 1, wherein the exhibition data generating unit generates the exhibition data not including the first player identification information.

3. The game system of claim 1, further comprising:
a group management unit configured to randomly grouping a plurality of players of the game into a plurality of groups and associate the plurality of groups with each other,
wherein the first display control unit allows the exhibition screen to be displayed in the game being played by the second player only when a first group including the first player is associated with a group including the second player.

4. The game system of claim 1, further comprising:
a player management unit configured to store player identification information unique to each of the plurality of players in dynamic association with player identification information of other players,
wherein the first display control unit allows the exhibition screen to be displayed in the game being played by the second player only when the player management unit stores the second player identification information in association with the first player identification information.

5. The game system of claim 1, further comprising:
an exhibition request receiving unit configured to receive from the first player an exhibition request including the first game medium identification information and setting information related to the first game medium,
wherein the exhibition data generating unit alters the setting information and generates the exhibition data including the altered setting information, the first game medium information, and the first game medium identification information.

6. The game system of claim 1, further comprising:
an exhibition request receiving unit configured to receive from the first player an exhibition request including the first game medium identification information and the setting information related to the first game medium,
wherein the setting information is selected from a limited number of preset options,
and wherein the exhibition data generating unit generates the exhibition data including the setting information, the first game medium information, and the first game medium identification information.

7. A game system comprising:
a game program storage unit configured to store a game program for performing a game on a terminal device;
a game medium identification information storage unit configured to store first game medium identification information unique to a first game medium for use in the game and second game medium identification information unique to a second game medium for use in the game, wherein the first game medium identification information is stored in association with first player identification information unique to a first player owning the first game medium, and wherein the second game medium identification information is stored in association with second player identification information unique to a second player owning the second game medium;
a player specifying information storage unit configured to store first player specifying information capable of specifying the first player and second player specifying information capable of specifying the second player;
an exhibition data generating unit configured to generate exhibition data including first game medium information related to the first game medium and the first game medium identification information and not including the first player specifying information;
a first display control unit configured to allow an exhibition screen generated based on the exhibition data to be displayed in the game being played by the second player;
a bid request receiving unit configured to receive from the second player a bid request including at least the first game medium identification information and the second game medium identification information;
a bid data generating unit configured to generate, based on the bid request, bid data including second game medium information related to the second game medium;
a second display control unit configured to allow a bid screen generated based on the bid data to be displayed in the game being played by the first player;
an exchange confirmation request receiving unit configured to receive from the first player an exchange confirmation request including at least the second game medium identification information; and
a game medium identification information updating unit configured to update the game medium identification information storage unit based on the exchange confirmation request such that the first game medium identification information is stored in association with the second player identification information, and the second game medium identification information is stored in association with the first player identification information.

8. The game system of claim 7, wherein the bid data generating unit generates the bid data not including the second player identification information.

9. A game system comprising:
a game program storage unit configured to store a game program for performing a game on a terminal device;
a group management unit configured to randomly grouping a plurality of players of the game into a plurality of groups and associate the plurality of groups with each other,
a game medium identification information storage unit configured to store first game medium identification information unique to a first game medium for use in the game and second game medium identification information unique to a second game medium for use in the game, wherein the first game medium identification information is stored in association with first player identification information unique to a first player owning the first game medium, and wherein the second game medium identification information is stored in association with second player identification information unique to a second player owning the second game medium;
a player specifying information unit storage unit configured to store the first player specifying information capable of specifying the first player and the second player specifying information capable of specifying the second player;
an exhibition data generating unit configured to generate exhibition data including first game medium information related to the first game medium and the first game medium identification information;
a first display control unit configured to allow an exhibition screen generated based on the exhibition data to be displayed in the game being played by the second player only when a first group including the first player is associated with a group including the second player;
a bid request receiving unit configured to receive from the second player a bid request including at least the first game medium identification information and the second game medium identification information;
a bid data generating unit configured to generate, based on the bid request, bid data including second game medium information related to the second game medium;
a second display control unit configured to allow a bid screen generated based on the bid data to be displayed in the game being played by the first player;
an exchange confirmation request receiving unit configured to receive from the first player an exchange confirmation request including at least the second game medium identification information; and
a game medium identification information updating unit configured to update the game medium identification information storage unit based on the exchange confirmation request such that the first game medium identification information is stored in association with the second player identification information, and the second game medium identification information is stored in association with the first player identification information.

10. The game system of claim 9, further comprising a group updating unit configured to update groups including the plurality of players.

11. A game system comprising:
a game program storage unit configured to store a game program for performing a game on a terminal device;
a player management unit configured to store player identification information unique to each of the plurality of players in dynamic association with player identification information of other players,
a game medium identification information storage unit configured to store first game medium identification information unique to a first game medium for use in the game and second game medium identification information unique to a second game medium for use in the game, wherein the first game medium identification information is stored in association with first player identification information unique to a first player owning the first game medium, and wherein the second game medium identification information is stored in association with second player identification information unique to a second player owning the second game medium;
a player specifying information storage unit configured to store first player specifying information capable of specifying the first player and second player specifying information capable of specifying the second player;
an exhibition data generating unit configured to generate exhibition data including first game medium information related to the first game medium and the first game medium identification information;
a first display control unit configured to allow an exhibition screen generated based on the exhibition data to be displayed in the game being played by the second player only when the player management unit associates the second player with the first player;
a bid request receiving unit configured to receive from the second player a bid request including at least the first game medium identification information and the second game medium identification information;
a bid data generating unit configured to generate, based on the bid request, bid data including second game medium information related to the second game medium;
a second display control unit configured to allow a bid screen generated based on the bid data to be displayed in the game being played by the first player;
an exchange confirmation request receiving unit configured to receive from the first player an exchange confirmation request including at least the second game medium identification information; and
a game medium identification information updating unit configured to update the game medium identification information storage unit based on the exchange confirmation request such that the first game medium identification information is stored in association with the second player identification information, and the second game medium identification information is stored in association with the first player identification information.

12. A method using a computer comprising the steps of:
storing game programs for performing games on a terminal device;
storing first game medium identification information unique to a first game medium for use in the game and second game medium identification information unique to a second game medium for use in the game, wherein the first game medium identification information is stored in association with first player identification information unique to a first player owning the first game medium, and wherein the second game medium identification information is stored in association with second player identification information unique to a second player owning the second game medium;
storing the first player specifying information capable of specifying the first player and the second player specifying information capable of specifying the second player;
generating exhibition data including first game medium information related to the first game medium and the first game medium identification information;
allowing an exhibition screen generated based on the exhibition data to be displayed in the game being played by the second player;
receiving from the second player a bid request including at least the first game medium identification information and the second game medium identification information;
generating, based on the bid request, bid data including second game medium information related to the second game medium and not including the second player specifying information;
allowing a bid screen generated based on the bid data to be displayed in the game being played by the first player;
receiving from the first player an exchange confirmation request including at least the second game medium identification information; and
updating the game medium identification information storage unit based on the exchange confirmation request such that the first game medium identification information is stored in association with the second player identification information, and the second game medium identification information is stored in association with the first player identification information.
